(19) United States
(12) Patent Application Publication
(10) Pub. No.: US 2008/0040161 A1
(43) Pub. Date: Feb. 14, 2008

(54) Software for generating documents using an object-based interface and item/property data storage with a bulk multimedia import utility

(75) Inventors: Peter J. Faux, West Des Moines, IA (US); David A. Schoney, West Des Moines, IA (US)

Correspondence Address: DAVIS, BROWN, KOEHN, SHORS & ROBERTS, P.C.;THE FINANCIAL CENTER, 666 WALNUT STREET, SUITE 2500, DES MOINES, IA, 50309-3993, US

(73) Assignee: MediNotes Corporation, West Des Moines, IA (US)

(21) Appl. No.: 11/789,475

(22) Filed: Apr. 25, 2007

Related U.S. Application Data
(60) Provisional application No. 60/795,355, filed on Apr. 27, 2006.

(51) Int. Cl. G06F 19/00

(52) U.S. Cl. 705/3

(57) ABSTRACT

An object-based computer software application for generating medical documents includes the use of metadata objects to represent user-interface components and medical objects based on the metadata objects. In addition, patient data objects are generated from medical objects as selected by a user. The metadata objects, medical objects and patient data objects are stored in and retrieved from a relational database. The application also makes use of a table structure of each of the three object components. The table structure includes a first table in which is stored the object and a second table in which is stored a plurality of properties associated with the object.

This application claims priority to U.S. Patent Application Ser. No. 60/795,355, filed Apr. 27, 2006.

### BACKGROUND OF THE INVENTION

1. Field of the Invention

The invention relates generally to a computer software system for generating medical notes and, more specifically, to a computer software system for generating documents which comprise a patient file using an object-based interface and item/property data storage and having a bulk multimedia import utility.

2. Background of the Art

Providing medical care to patients involves the generation of large quantities of paper which comprise a patient's medical file. Typically, the patient file is created at the first visit of the patient to a treatment facility, such as a doctor's office, a clinic, a hospital, or the like. The file includes the patient's medical history, treatments, referring physician information, insurance information, current drugs prescribed, test results, diagnoses, X-rays and other image-based information, and notes taken by the healthcare professional to record information regarding the patient conditions, complaints, care instructions and the like. The patient file is updated whenever new information is received, such as upon a subsequent patient visit, the return of laboratory results, correspondence from a consulting physician, and so on. A patient's file will also contain copies of correspondence sent to a physician to which the patient has been referred.

Most healthcare providers still generate notes for patient files by either writing them on forms or in long-hand, or by dictating notes which are then transcribed by non-medical personnel. This process requires significant time by the healthcare provider or the cost of the employment of transcribers or a transcription service.

There have been many software systems developed and sold which assist the healthcare provider in generating and maintaining the patient files. One type of system uses voice recognition software to automatically transcribe dictated recording of notes. While such software continues to improve, significant amounts of time must be spent in training the system and, even with much training, the software still makes errors that need to be corrected by human review.

An additional difficulty in using existing systems is that all information must be added and retrieved in text form, whereas much of medicine makes use of anatomic, physiological and other non-textual information. Time savings can be realized if the user-interface of the medical note-taking software provided information to the healthcare professional in a graphical interface and also provided object-based information storage and retrieval capabilities.

### SUMMARY OF THE INVENTION

The invention consists of a computer software system for generating medical documents for a patient medical file. The software system includes a user interface with a plurality of components selected by a healthcare provider for the entry of information to be included in the medical documents. The user interface components include metadata objects that relate to medical objects. The healthcare provider selects from the medical objects and the software system generates patient data objects which are added to the medical file of the patient. The software system includes a relational database which is used for storing and retrieving the metadata objects, the medical objects and the patient data objects. Each of the three object components are stored in a table structure wherein a first table stores the object and a second table stores a plurality of properties associated with the object.

In a specific embodiment of the invention, the user interface includes components selected by the healthcare provider for monitoring patient data over time from a list that displays to the healthcare provider patient object data specific to a selected medical object. Using this embodiment, a healthcare provider is able to monitor the historical progression of patient object data over time.

In another embodiment of the invention, the user interface includes components selected by the healthcare provider corresponding to a current version of data of a selected patient object data for a specific medical object. This embodiment allows a healthcare provider to pull previous data for a specific medical object, by patient, into a current version of the patient's object data. The healthcare provider may use the previous values for any object created for the patient.

In an alternative embodiment of the invention, the user interface includes components selected by a healthcare provider to generate a medical document that recited patient data objects created outside of the document. This interface is used by a healthcare provider to bring individual patient objects into the document being generated.

In still another embodiment, the user interface includes components selected by a healthcare provider to associate a medical object with a position in a medical document. In this embodiment, a new metadata object type is created that does not carry any patient data but instead represents a position within a document which is associated with a medical object. This allows medical objects to be placed within a document without user intervention.

The user interface may also include components consisting of a list of patient data objects from which the healthcare provider selects a set for identifying by level of risk for the patient a selected medical object. Using this interface, a healthcare provider can created a preventative medicine item template or an item specific to a particular patient which may be used to generate a document that is given to the patient proscribing preventative medicine steps that can be taken. The interface can also be used to generate notices for follow-up exams or the like consistent with the preventative medicine program.

The software may also include a multimedia bulk import utility that permits the bulk import of graphics from imaging programs. The utility will pull the graphics from the imaging program into the software by looking in a specified directory for the file created by the imaging software. In a preferred embodiment, the multimedia bulk import utility pulls the graphics into the software from the Scandex imaging program by looking in the user-specified directory for a text file created by the Scandex program. The text file must be laid out in the format “client number, Image topic name, Image name, Image Date, Image filename”.

### BRIEF DESCRIPTION OF THE DRAWINGS

FIG. 1 is a schematic diagram showing the relationship between a user interface of the system and metadata objects, medical objects and patient data objects used in the system.

FIG. 2 is a sample dialog box that appears on the user interface when entering patient data concerning “pulses.”

FIG. 3 is a dialog box displaying nine panes of information regarded a selected patient, Queen, L.

FIG. 4 is a dialog box from which a user is able to call and enter the last value from the database of a note for a particular patient.

FIG. 5 is a dialog box from which a user is able to bring forward and enter objects created outside of the present document being prepared.

FIG. 6 is a main window dialog box in which Preventative Medicine from the left panel has been selected and which displays a Method panel and a Rule panel associated with a Preventative Medicine module of the present invention.

FIG. 7 a dialog box which displays all patients which match the criteria specified by a user and entered in the top portion of the dialog box.

FIG. 8 is the initial dialog box displayed by a wizard used to assist a user in creating new methods and rules used in the Preventative Medicine module.

FIG. 9 is an example of an Object Explorer dialog box of the Preventative Medicine module.

FIG. 10 is a dialog box in which a name for a new method is entered.

FIG. 11 is a dialog box from which a final status is selected and from which additional, preliminary status items may be selected.

FIG. 12 is a dialog box in which the name of the new rule is entered.

FIG. 13 is a dialog box showing a list of diagnostic codes for selection by a user to add to the rule being created.

FIG. 14 is a dialog box showing a list of family history items for selection by a user to add to the rule being created.

FIG. 15 is a dialog box which displays the information regarding the selected rule and from which editing of the rule may be accomplished.

FIG. 16 is a dialog box showing the creation of the child topic “Elbow ROM” under the main topic “Range of Motion.”

FIG. 17 a dialog that includes a list of panels a user may select for addition to the topic; in the example, Notes and Patient Picture have been selected.

FIG. 18 is a New Panel dialog box.

FIG. 19 is a dialog box which can be used to order the panels.

FIG. 20 is an Object Editor dialog box from which a user may select where the placeholder will be positioned.

FIG. 21 is a Template Builder dialog box showing where the object is located when pulled into the note template.

FIG. 22 a dialog box which displays a list of panels a user may select for addition to a topic.

FIG. 23 is a dialog box from which a user can access the multimedia bulk import utility.

### DETAILED DESCRIPTION OF THE PREFERRED EMBODIMENTS

The invention is an object-oriented software application that produces medical documents using an object-based user interface and item/property data storage. Data storage is set up to store metadata objects, medical objects built on the metadata objects, and patient objects which are the output of the medical objects. A relational database is used to store and retrieve metadata objects, medical objects, and patient data objects. The table structure for the three object components is set up as two tables per object type. The first table stores the object and the second table stores the properties associated with the object.

Metadata objects are a description or definition of electronic data, or data about data, or information about information, and include information describing aspects of actual data items, such as name, format, content, and the control of or over data. Metadata objects comprise a structured set of descriptive elements to describe an information resource or, more generally, any definable entity. Metadata objects include Beginning Phrase, Minimum Value, Maximum Value, Increment, Bilateral, Units, and Default Value.

Medical objects are user interface components that describe or depict a medical attribute, location, or condition. Examples of medical objects include Beginning Phrase, Minimum Value, Maximum Value, Increment, Bilateral, Units, and Default Value.

Patient data objects are user interface components that associate a medical object with a particular patient.

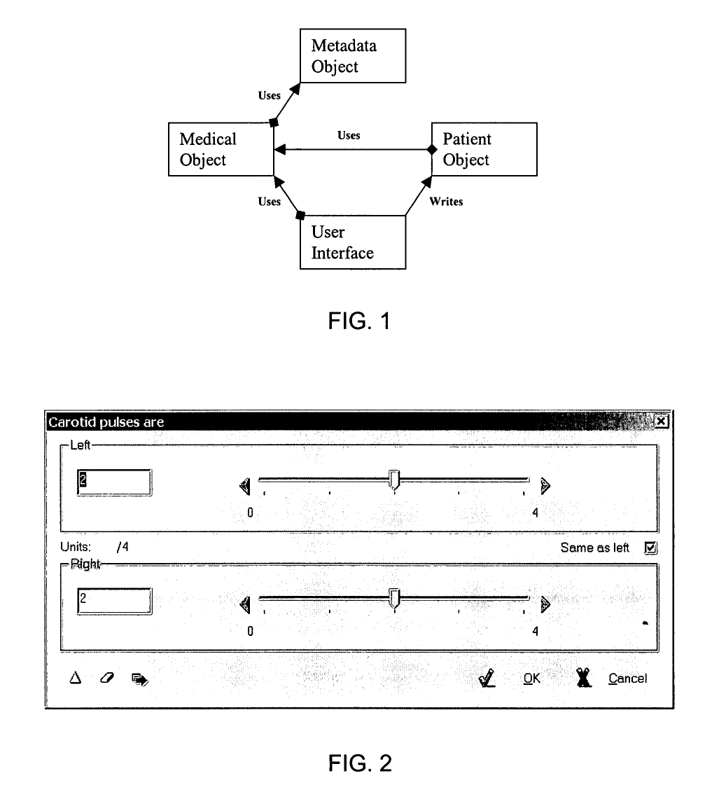

In the present invention, metadata objects are used to represent user interface components. These user interface components are used to communicate medical thoughts or ideas. A schematic diagram of the user interface and the three types of objects is illustrated in FIG. 1. If, for example, a user interface component that represents a measurement would have a data structure in the form:

Metadata Data Object: Measurement

Properties:

Beginning Phrase:

Minimum Value:

Maximum Value:

Increment:

Bilateral:

Units:

Default Value:

Using the metadata data object, a medical thought or idea can be represented. For example, if the medical object is “pulses”, the user interface may have a data structure in the form:

Medical Object: Pulses→carotid

Properties:

Beginning Phrase: Carotid pulses are

Minimum Value: 0

Maximum Value: 4

Increment: 0

Units: /4

Bilateral: Yes

Default Value: 2

A dialog box that would be displayed on the user interface to allow the user or healthcare provider to input or select information to generate a patient note on the pulses of a patient is shown in FIG. 2. Input or selection of data with the user interface produces patient object data as well as a syntactically correct and complete medical thought. Using the data from the dialog bog of FIG. 2, the sentence “Carotid pulses are ¾ left and 2/4 right.” is produced. If the patient's name is Jane Smith, the data of the examination is Jan. 1, 2005, the patient object data generated would be as follows:

Patient Object Data:

Object: Pulses→carotid

Patient: Jane Smith

Date: Jan. 01, 2005

Left: 3

Right: 2

Text: Carotid pulses are ¾ left and 2/4 right.

Patient Monitor Module

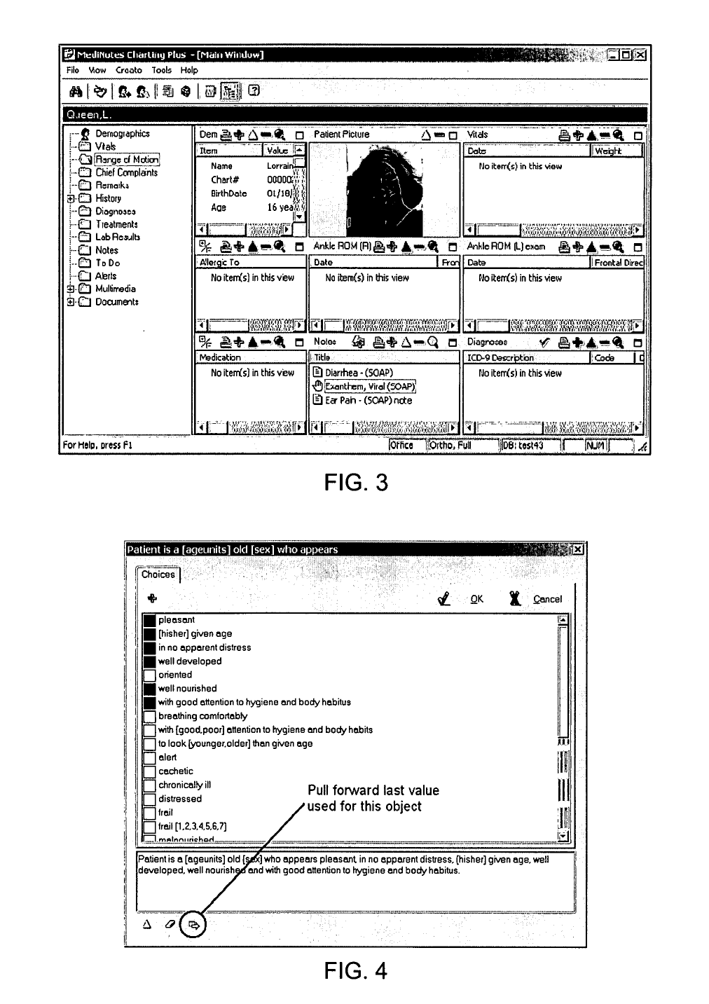

One of the uses or embodiments of the present invention is an application referred to as the Patient Monitor Module. Using metadata objects, medical objects and patient data objects, a user interface was created to monitor the historical progression of patient object data over time. This is done in a generic model that allows any medical object to be monitored by a healthcare provider or other user. The Patient Monitor Module displays a list of topics of patient object data and allows each user to customize the main or front screen view to their specifications. Custom topics can be added to the front screen and multiple panels of patient object data can be added to those topics. As shown in FIG. 3, the topics are listed in the left hand column and the selected topic, Range of Motion, calls to the display nine separate panels; the panels in this example are demographics, patient picture, vitals, allergies, ankle ROM (R) (range of motion of right ankle), ankle ROM (L) (range of motion of left ankle), medication, notes, and diagnoses. Each panel can be maximized for a larger view if desired. Topics and panels can be created, edited and managed by the user. In addition, sub-topics or “child topics” can be nested under main level topics. Patient data from the database is listed in the corresponding panels. The healthcare provider is able to view the patient's historical object data and have it available for making decisions about current diagnoses and treatments under consideration. The Patient Monitor module will be discussed in further detail below.

Last Value Module

A user interface is created which uses a combination of patient object data with specific medical objects to pull previous data for a specific medical object, by patient, into a current version of the patient's object data. The user interface allows a healthcare provider to use the previous values for any object created for that patient. In the preferred embodiment described herein, a button appears in the lower margin of each of the user object interface components that retrieves the data from the object storage system or database, an example of which is illustrated in FIG. 4.

Pull Forward Module

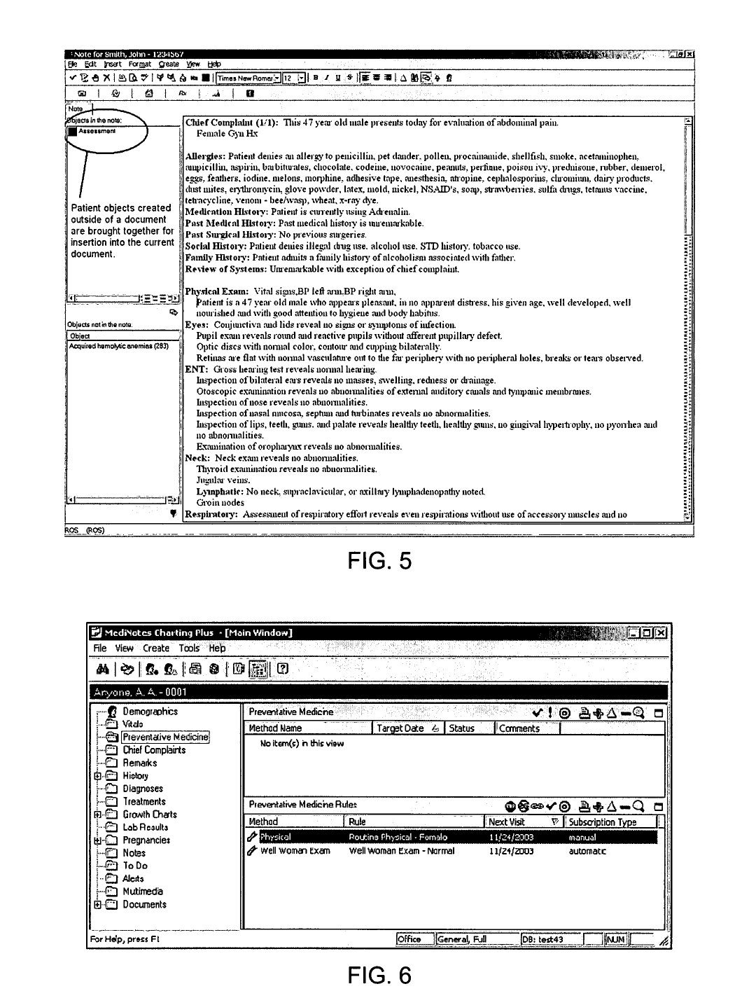

A user interface is created which uses a combination of patient object data with specific medical objects to bring individual patient objects into a document. In this way, patient object data created outside of the document currently being created are brought together for insertion into the current document. An example of a user interface employing the Pull Forward Module is illustrated in FIG. 5.

Placeholder Module

By creating a new metadata object type that does not carry any patient data but instead represents a position within a document, a medical object is given a placeholder property which associates a medical object with a placeholder object. This allows medical objects to be placed within a document without user intervention. Using the Medical Object: Pulses→carotid example described above, a new metadata object type “Placeholder” is created and associated with the medical object “Labs” for instance, the properties of the “Pulses→carotid” medical object are now as follows:

Medical Object: Pulses→carotid

Properties:

Beginning Phrase: Carotid pulses are

Minimum Value: 0

Maximum Value: 4

Increment: 0

Units: /4

Bilateral: Yes

Default Value: 2

Placehoder: [Labs]

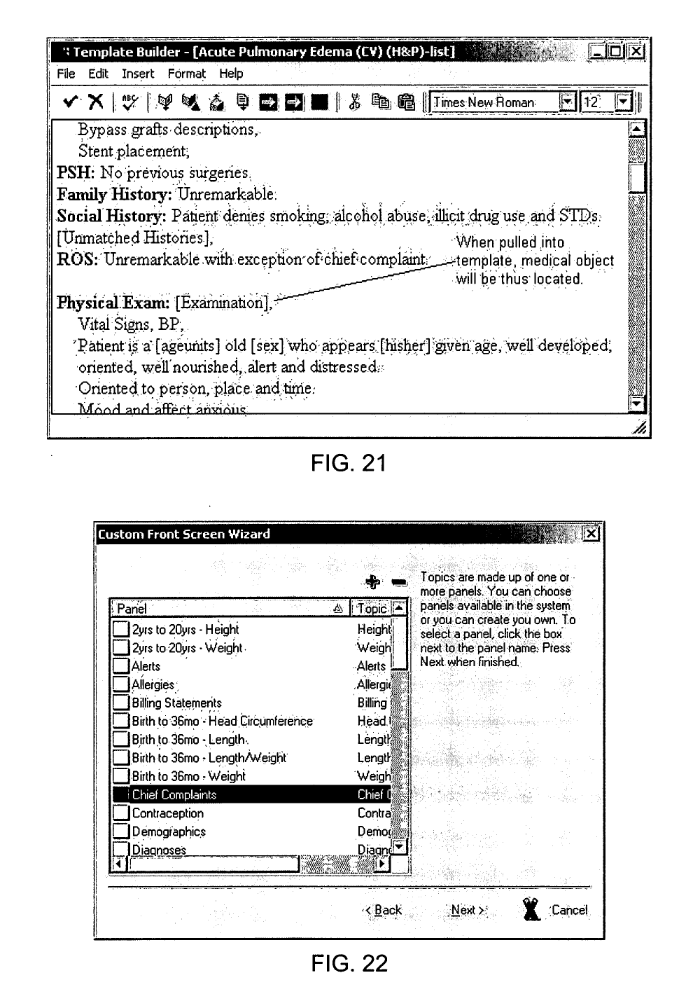

The Pulses→carotid object is placed within a newly created document at the position specified by the placeholder object (FIG. 20). FIG. 21 is a dialog box showing where the object will be located when pulled into the note template.

Preventative Medicine Module

Preventative medicine is an increasingly important part of medical practices. The present software system permits the creation of customized preventive medicine items to suit a particular medical practice, provides the ability to assign those items either automatically to all patients or individually to particular patients, and to set reminders as to when preventative medicine items are to be scheduled for each patient.

Preventative Medicine Module—Example

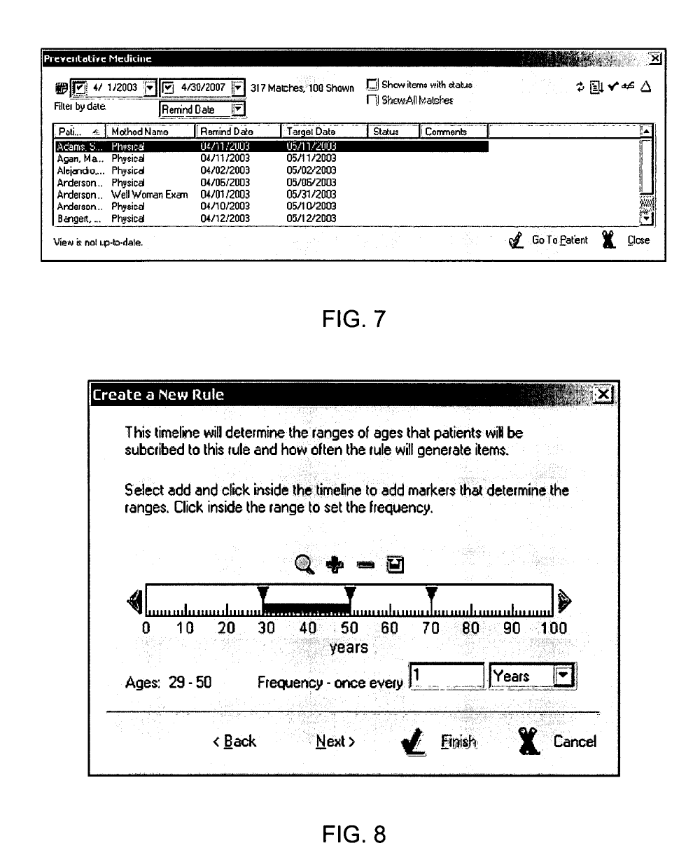

Methods and rules created by a user are assigned to the appropriate patients and then appear on the front screen of the program (FIG. 6). The rules that have been assigned to a patient are displayed, whether those rules have been manually or automatically subscribed, the status of each item, and the next target date for each rule. This information is displayed by selecting the Preventative Medicine category in the left pane. A list of all preventative medicine items for all patients is displayed by selecting the Preventative Medicine menu item under the View dropdown list (FIG. 7).

Whether using the manual or automatic method, and number of rules can be established. Rules may be used, for example, to assign a certain preventative medicine item for a subset of patients using criteria such as age, sex, diagnostic codes, treatment codes and family history. For example, a healthcare provider may choose to advise male patients aged 40 and over, post-menopausal women, and younger persons with risk factors for CVD, such as smoking, high blood pressure, high cholesterol or diabetes, to take aspirin on a regular basis. The rules can be used to set the date range, frequency, timeline increment, and so on. An example of a dialog box for the creation of new rules is illustrated in FIG. 8.

When a rule is created, by default it will automatically subscribe every eligible patient in the database. Alternatively, rules can be created which are not automatically subscribed to by all patients.

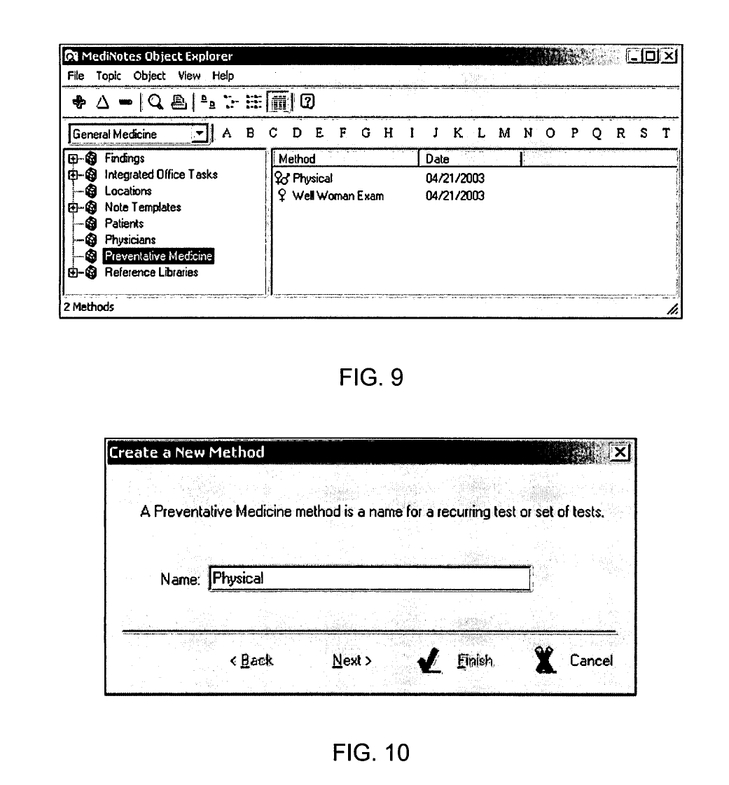

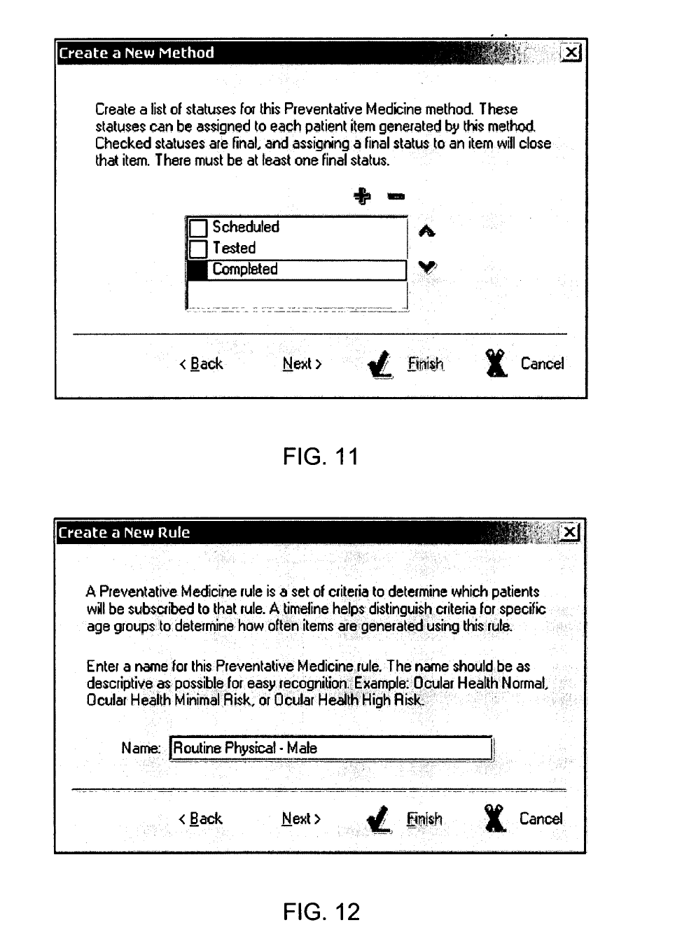

An example of the creation of a new method and rule will be discussed. To begin, the Preventative Medicine item is selected from the list in the left pane of the Object Explorer screen (FIG. 9). The New icon (the plus sign) is selected to call a wizard to assist in creating the methods and rules within the Preventative Medicine module. The first dialog box (FIG. 10) asks for a name of the new method, which in this example is labeled Physical. When Next is selected a dialog box (FIG. 11) appears which prompts for the entry of a final status (Completed, in this example); additional preliminary status items may also be entered. Next, a name for the first rule that will be associated with the method is entered. In this example, the rule is named Routine Physical—Male, entered in the next dialog box (FIG. 12). Additional rules can be added in a like manner. The next step is to set a frequency that the rule will be assigned to different age groups. The wizard displays the Create New Rule dialog box (see FIG. 8) and the Define Frequency button (far right hand) is selected. The end point markers are then moved to define the age range for the rule (in FIG. 8, it is between ages 29 and 50). Then the frequency is specified using the entry box and dropdown list box in the lower right. The wizard will then call a dialog box (not shown) which will allow the user to set the sex of the patient to which the rule will apply.

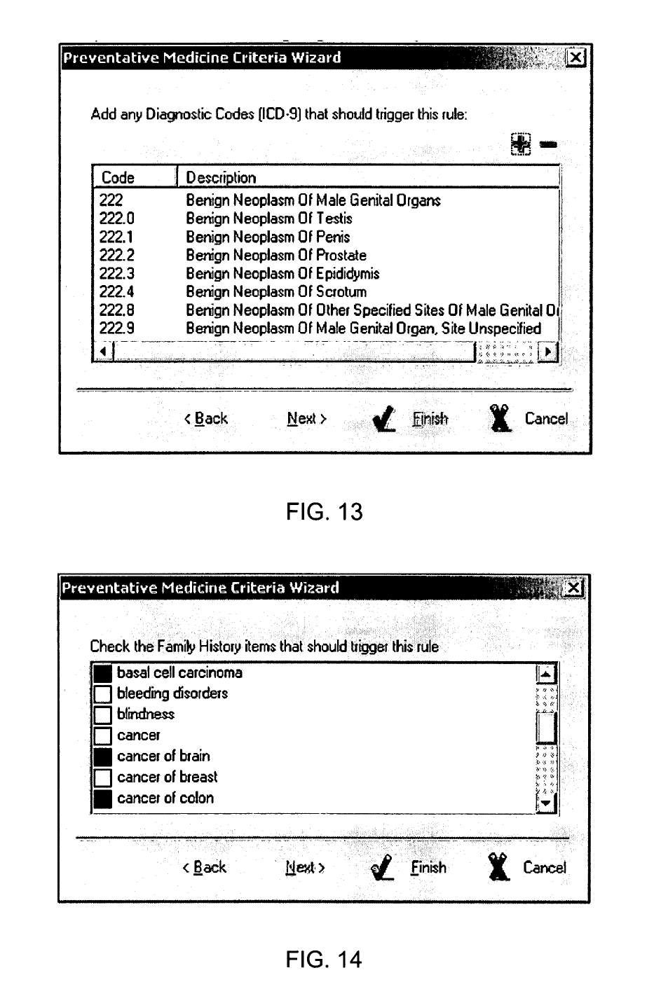

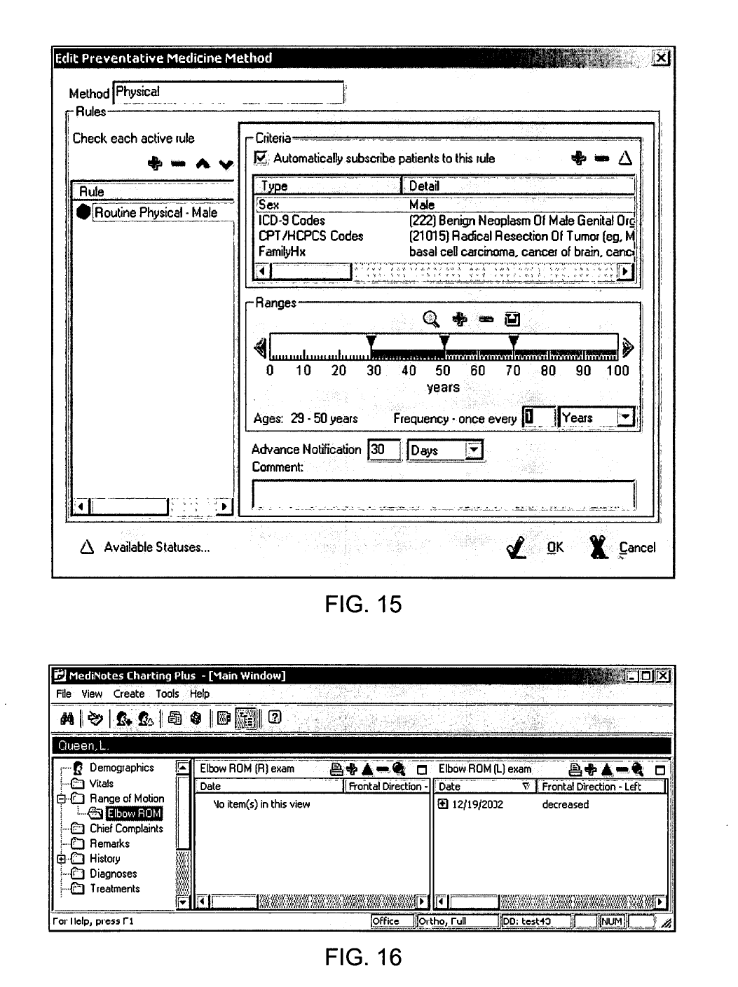

The wizard will next call a dialog box for the entry of diagnostic (ICD-9) codes to add to the rule (FIG. 13). The user can select as many of the diagnostic codes from the list as desired to form part of the rule. When finished, the wizard displays a dialog box for the addition of treatment (CPT/HCPCS) codes to the rule in a manner similar to the entry or addition of diagnostic codes. The next dialog box called by the wizard allows the entry of family history information from a list of family history items (FIG. 14). Upon completion of the above steps, the resulting dialog box will appear as in FIG. 15. Note that the diagnostic (ICD-9) codes selected include [222] Benign Neoplasm of Male Genital Organ, the treatment (CPT/HCPCS) codes selected include [21015] Radical Resection of Tumor, and the Family History items selected include basal cell carcinoma, cancer of brain, cancer of colon.

The Preventative Medicine module also allows for the prioritization of rules so that patients will be subscribed to rules in the order of priority. This will ensure that a patient with a more specific rule will be subscribed to that rule rather than to a more general rule that would otherwise apply. All of the rules associated with a patient will be displayed on the main window (see, for example, FIG. 6, lower pane). The display will also provide information on whether the rule was automatically or manually subscribed, the status of each item, and the next target date for each item.

Patient Monitor Module—Example

The Patient Monitor module allows each user to customize the main or front screen to desired specifications by adding topics and multiple panels. The example shown in FIG. 3 includes nine panels. An example of creating, editing and managing topics and panels will be described.

Most of the objects utilized in the present application can be added to the front screen using the Patient Monitor module. For example, the object Chief Complaint can be added to the front screen so that it can be pulled easily by a user into the note or document being created. To add a Chief Complaint, the topic Demographics is selected from the left pane of the dialog box shown in FIG. 3. After selection of demographics, a right-click will display a list from which New is selected. A wizard will then display a dialog box (not shown) in which the name of the topic is entered. Next, the wizard displays a dialog box (FIG. 22) that includes a list of panels a user may select for addition to the topic. Pressing Next will take you to a dialog box (not shown) allowing rearrangement of topics. Clicking Finish will complete the process and add the panel.

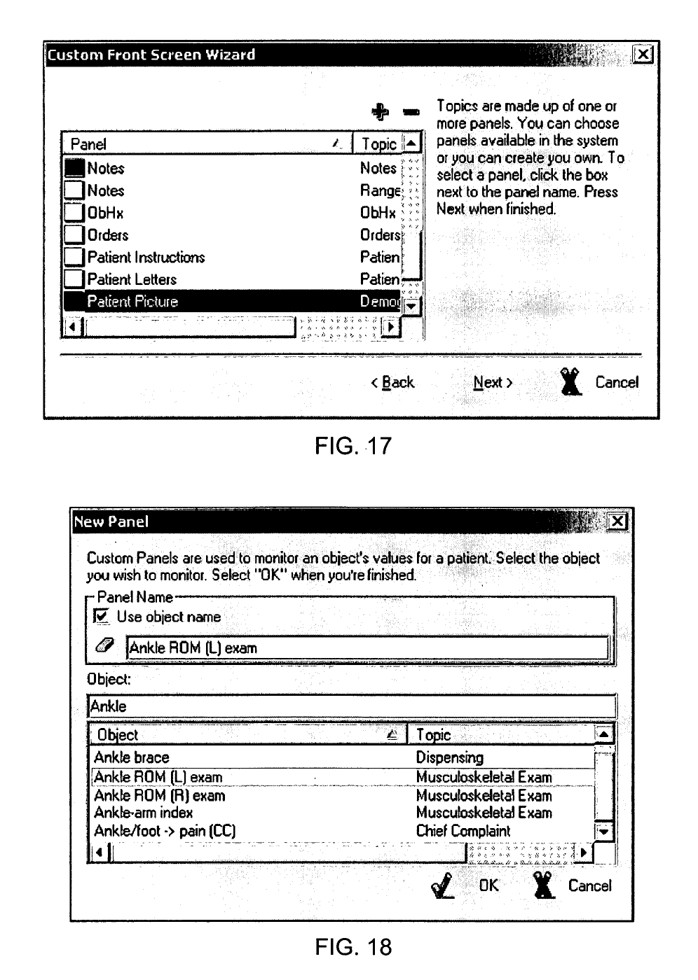

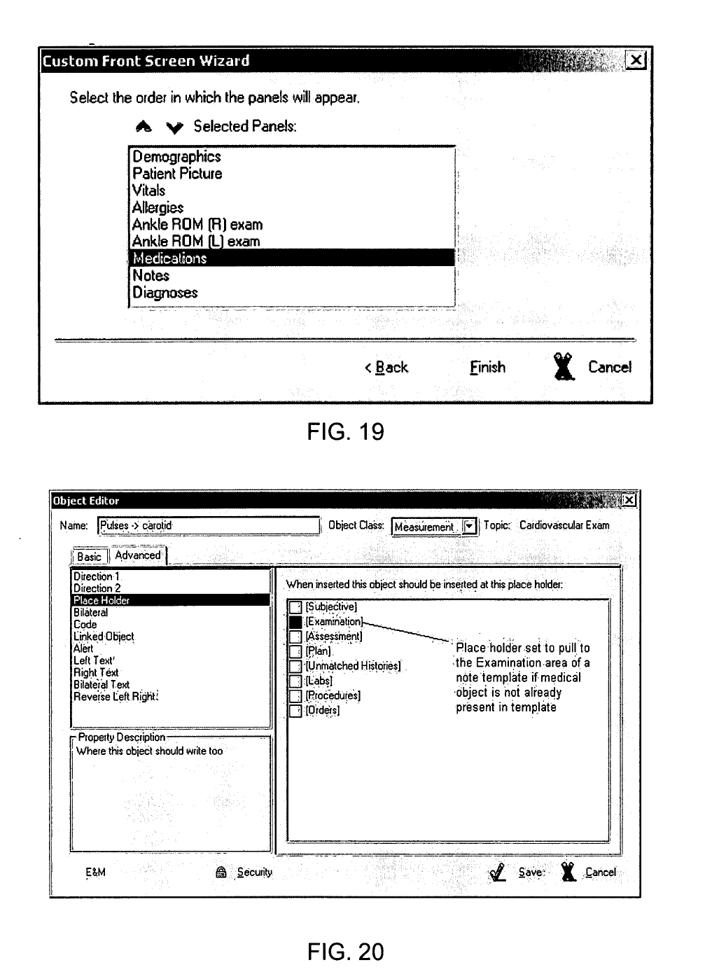

Topics nested under other topics, referred to herein as Child Topics, can be created under the main level topics; in this example, as shown in FIG. 16, Range of Motion has been selected. After selection of the main topic from which a Child Topic is to depend, a right click will display a list from which New Child is selected. A wizard will then display a dialog box (not shown) in which the name of the Child Topic is entered. Next, the wizard displays a dialog box (FIG. 17) that includes a list of panels a user may select for addition to the topic. In the example, Notes and Patient Picture have been selected. To create a new panel, select the New icon (the “+” sign) from the dialog box of FIG. 17. The wizard will display a dialog box (FIG. 18). Typing in the Object pane will bring up the area of a list with corresponding starting letters. The user selects the appropriate object from the list and the object name will automatically populate the Panel Name field. Pressing OK will add the panel. As many panels as desired can be added. When finished, Next is selected and a dialog box is displayed (FIG. 19) which can be used to order the panels. A single panel of the front screen is maximized by pressing the Maximize icon in the upper right corner of the panel and minimized by pressing the Minimize icon.

Topics can be edited. The topic is selected (see, FIG. 3) and a right click displays a list from which Edit is selected. A wizard begins which allows a user to edit the name of the topic, edit the panels associated with the topic, add panels, rearrange the order of the panels, and the like. Moving panels on the front screen is accomplished by passing the cursor over the panel to be moved. As it passes over the panel, the cursor changes into a “hand” symbol. A left click will grab the panel and it can be moved by a mouse and dropped where desired by releasing the left mouse button.

The software may also include a multimedia bulk import utility that permits the bulk import of graphics from imaging programs. The utility will pull the graphics from the imaging program into the software by looking in a specified directory for the file created by the imaging software. In a preferred embodiment, the multimedia bulk import utility pulls the graphics into the software from the Scandex imaging program by looking in the user-specified directory for a text file created by the Scandex program. The text file must be laid out in the format:

client number,Image topic name,Image name,Image Date,Image filename

client number,Image topic name,Image name,Image Date,Image filename

client number,Image topic name,Image name,Image Date,Image filename

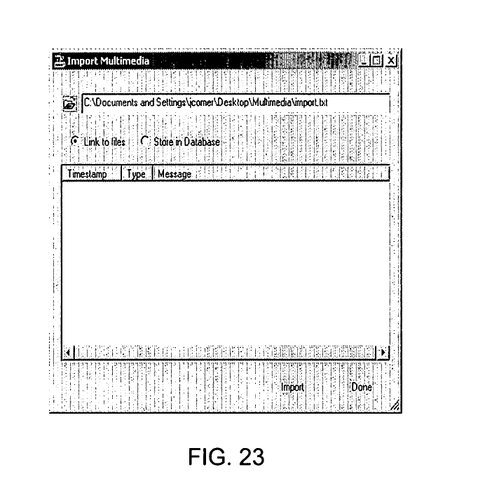

To access the multimedia bulk import utility, a user goes to the menu “Start>Programs>Medinotes>Utility” and selects “Import Multimedia”. The screen appearing in FIG. 23 will appear. The user browses for the exported test file. Two options are given, either to link to the files or to store the file in the user database. The “Import” button is selected to import the files.

If the user chooses the “link to file” option, this import will pull in the path of each image file to the Multimedia folder on the front screen (FIG. 23). If the user chooses “Store in Database”, then the import will pull each image to the Multimedia file on the front screen.

The foregoing description and drawings comprise illustrative embodiments of the present inventions. The foregoing embodiments and the methods described herein may vary based on the ability, experience, and preference of those skilled in the art. Merely listing the steps of the method in a certain order does not constitute any limitation on the order of the steps of the method. The foregoing description and drawings merely explain and illustrate the invention, and the invention is not limited thereto, except insofar as the claims are so limited. Those skilled in the art who have the disclosure before them will be able to make modifications and variations therein without departing from the scope of the invention.

We claim:

1. A computer software application using object-oriented programming for generating medical documents, comprising:
(a) metadata objects used to represent user-interface components;
(b) medical objects based on the metadata objects;
(c) patient data objects generated from medical objects as selected by a user; and
(d) a relational database for storing and retrieving the metadata objects, the medical objects and the patient data objects.

2. A computer software application as defined in claim 1, further comprising a table structure of each of the three object components and wherein the table structure comprises a first table in which is stored the object and a second table in which is stored a plurality of properties associated with the object.

3. A computer software application a defined in claim 1, further comprising a user interface for monitoring patient object data over time comprising a user interface list that displays to a user patient object data specific to a specified medical object.

4. A computer software application as defined in claim 1, further comprising a user interface by which a user selects a current version of data of a selected patient's object data for a specific medical object.

5. A computer software application as defined in claim 1, further comprising a user interface by which a user generates a medical document which recites patient data objects created outside of the document.

6. A computer software application as defined in claim 1, further comprising a metadata object which represents a position within a medical document and which associates a medical object with the position.

7. A computer software application as defined in claim 1, further comprising user interface by which a user generates a list of one or more medical objects or patient data objects for identifying by varying levels of risk of a patient of a selected medical object.
